(19) United States
(12) Patent Application Publication
(10) Pub. No.: US 2014/0242985 A1
(43) Pub. Date: Aug. 28, 2014

(54) ACTIVE SCANNING IN WIRELESS NETWORK

(71) Applicants: Jarkko Kneckt, Espoo (FI); Mika Kasslin, Espoo (FI); Eng Hwee Ong, Espoo (FI); Gabor Bajko, Santa Clara, CA (US)

(72) Inventors: Jarkko Kneckt, Espoo (FI); Mika Kasslin, Espoo (FI); Eng Hwee Ong, Espoo (FI); Gabor Bajko, Santa Clara, CA (US)

(73) Assignee: Nokia Corporation, Espoo (FI)

(21) Appl. No.: 14/352,627

(22) PCT Filed: Oct. 28, 2011
(86) PCT No.: PCT/US2011/058346

§ 371 Date: Apr. 17, 2014

(51) Int. Cl. H04W 48/16; H04W 76/02

(52) U.S. Cl. CPC H04W 48/16; H04W 76/02
USPC 455/434

(57) ABSTRACT

This document discloses a solution for preparing for a connection establishment in a wireless network. According to an aspect, transmission of a request message from the wireless apparatus is carried out on a channel. Thereafter, a response message is acquired on said channel as a response to the request message, the response message being originated from a second wireless apparatus which is in an unassociated state with said wireless apparatus, and the response message comprising information on at least two wireless networks operating on at least one of said channel and another channel. Then, the received response message may be utilized in the connection establishment.

### FIELD

The invention relates to the field of radio communications and, particularly, to signalling related to active scanning in a wireless network.

### BACKGROUND

Fast link setup is a desired feature in wireless networks. Before establishing a new connection, a wireless device may scan for another wireless device with which to establish the connection. This scanning procedure should be optimized so as to provide a connection establishment without excessive signalling overhead in a radio interface.

### BRIEF DESCRIPTION

According to an aspect of the present invention, there are provided methods as specified in claims 1 and 6.

According to another aspect of the present invention, there are provided apparatuses as specified in claims 14 and 19.

According to another aspect of the present invention, there is provided an apparatus as specified in claim 28.

According to yet another aspect of the present invention, there is provided a computer program product embodied on a computer readable distribution medium as specified in claim 29.

Embodiments of the invention are defined in the dependent claims.

### LIST OF DRAWINGS

Embodiments of the present invention are described below, by way of example only, with reference to the accompanying drawings, in which

FIG. 1 illustrates a wireless communication scenario to which embodiments of the invention may be applied;

FIGS. 2 and 3 illustrate flow diagrams of processes related to preparing for a connection establishment according to some embodiments of the invention;

FIG. 4 is a signalling diagram of an active probing procedure according to an embodiment of the invention;

FIGS. 5 and 6 illustrate processes for filtering reported networks according to some embodiments of the invention; and

FIGS. 7 and 8 illustrate block diagrams of apparatuses according to some embodiments of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features and structures that have not been specifically mentioned.

A general architecture of a wireless telecommunication system to which embodiments of the invention may be applied is illustrated in FIG. 1. FIG. 1 illustrates groups of wireless communication devices forming wireless networks that may be referred to as basic service sets (BSS). A BSS may be defined by a group of wireless communication devices comprising an access point (AP) 104, 108, 110 and one or more terminal stations (STA) 114, 116 communicating with the access points 104, 108 of their respective groups. The STA 112 may be considered to be in an idle or unassociated state here and searching for a BSS to connect with. The BSS is a basic building block of an IEEE 802.11 wireless local area network (WLAN), and each BSS may have a determined coverage area 100, 102, 106 defined by the coverage area of the AP, for example. The most common BSS type is an infrastructure BSS that includes a single AP together with all associated, non-access-point STAs. The AP may be a fixed AP as AP 104, 110, or it may be a mobile AP as AP 108. The APs 104, 108, 110 may also provide access to other networks, e.g. the Internet. In another embodiment, at least one of the BSSs, is an independent BSS (IBSS) or a mesh BSS (MBSS) without a dedicated AP, e.g. the communication device 108 may in such an embodiment be a non-access-point terminal station. While embodiments of the invention are described below in the context of the above-described topologies of IEEE 802.11, it should be appreciated that other embodiments of the invention are applicable to networks based on other specifications, e.g. WiMAX (Worldwide Interoperability for Microwave Access), UMTS LTE (Long-term Evolution for Universal Mobile Telecommunication System), and other networks having cognitive radio features, e.g. transmission medium sensing features and adaptiveness to coexist with radio access networks based on different specifications and/or standards.

The BSSs are represented by the APs and/or STAs connected to each other, thereby establishing a BSS. Any one of the STAs 112, 114, 116 may establish a connection to any one of the BSSs, provided that the BSSs do not exclude the STAs from their list of devices allowed to connect to the BSSs. The connection establishment may include authentication in which an identity of a STA is established in the AP. The authentication may comprise exchanging an encryption key used in the BSS. The authentication may be based on shared key authentication or on an authentication, authorization and accounting (AAA) protocol, etc. After the authentication, the AP and the STA may carry out association in which the STA is fully registered in the BSS, e.g. by providing the STA with an association identifier (AID) for frame transmissions. For example, the STA 112 may establish a connection to any one of the APs 104, 108, 110.

The 802.11n specifies a data transmission mode in which a STA can have only one secondary channel which results in a maximum bandwidth of 40 MHz. The primary channel is used in all transmissions, and with associated devices supporting only the 20 MHz mode. The secondary channel may be used with clients supporting wider transmission bandwidths, wherein the primary channel communication is extended by using the secondary channel as additional bandwidth. A further definition in 802.11n is that the primary and secondary channels are adjacent. IEEE 802.11ac task group is developing an extension to such a data transmission model to provide for wider bandwidths by increasing the number of secondary channels from 1 up to 7, thus resulting in bandwidths of 20 MHz, 40 MHz, 80 MHz, and 160 MHz.

The primary channel may be used for connection establishment comprising association between two wireless apparatuses between which the connection is to be established. A wireless apparatus being in an unassociated state and preparing for the association may scan for channels in order to detect a signal indicating presence of another wireless apparatus for association. IEEE 802.11 network discovery mechanisms define two modes: passive and active scanning. In the passive scanning, the wireless apparatus scans a channel for a determined period of time. If a wireless network is discovered, the wireless apparatus may proceed to connection establishment or, otherwise, it tunes to another channel. The wireless apparatus may scan for beacon frames or any other frames originated from any AP or, alternatively, frames that meet given criteria e.g. a determined identifier. When the wireless apparatus uses the active scanning, it generates probe request frames and transmits them to request APs or, in general, other wireless apparatuses to reply with probe response frames. The rules applied to the scanning device (e.g. a STA) and the responding device (e.g. an AP) during the active scanning may be defined as follows. The scanning device may transmit one or more probe request frames comprising a service set identifier (SSID) field and/or a BSS identifier field specifying condition(s) as to which wireless apparatus should respond to the probe request. The scanning device may also reset a probe timer to zero and start it upon transmitting the probe request. If the scanning device detects no signal with sufficiently high energy on the channel on which the probe request was transmitted before the probe timer reaches a minimum probe response time, it tunes to a next channel if any. Otherwise, the scanning device may wait on the channel until the probe timer reaches a maximum probe response time and, thereafter, the scanning device processes all received probe responses. Optionally, the scanning device may then tune to scan the next channel, if any. The probing procedure provides the scanning device with information on the wireless networks present in the area and, as a consequence, enables the scanning device to select a wireless network with which to establish a connection. The responding device receiving the probe request may respond with a probe response if an address 1 field in the probe request frame is a broadcast address or an individual medium access control (MAC) address of the responding device, if the SSID in the probe request is a so-called wildcard SSID, the SSID in the probe request is the specific SSID of the responding device, or the specific SSID of the responding device is included in an SSID list element of the probe request, or the specific Mesh ID in the probe request is the specific Mesh ID of the responding device, or an address 3 field in the probe request is a wildcard BSSID, or the BSSID of the responding device, or the MAC address of the peer device in mesh BSS. Further conditions for responding to the probe request may also be set. In general, the probe request specifies the conditions defining the devices that should respond with the probe response. All devices that fulfil the conditions may attempt to transmit the probe response frame.

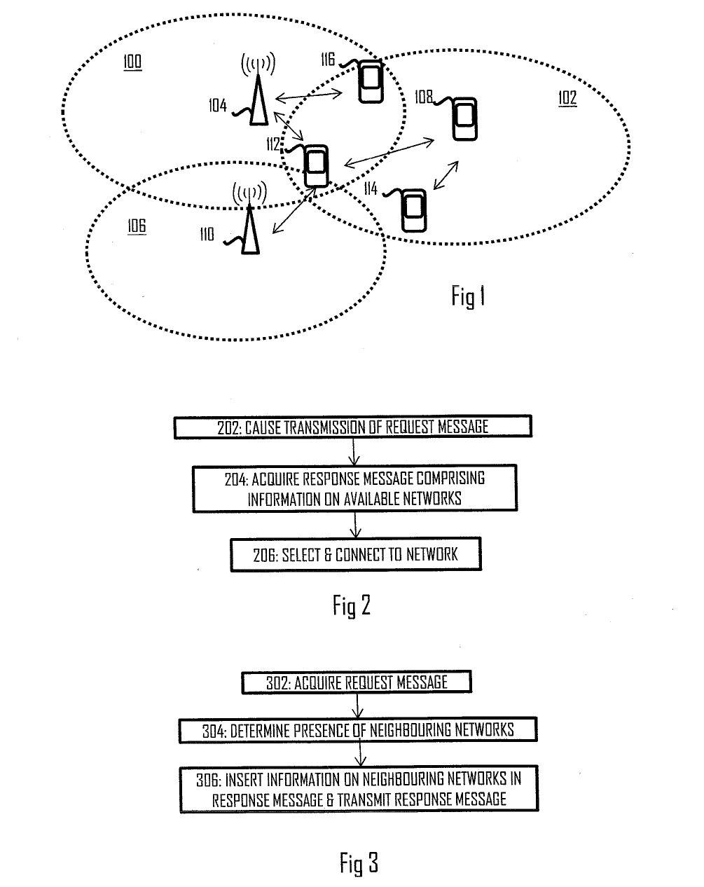

Let us now consider some embodiments of the present invention for preparing a connection establishment in a wireless apparatus, e.g. in the STA 112 that is in an unassociated state with respect to all or some of the wireless networks of FIG. 1. FIG. 2 illustrates a flow diagram of an embodiment of such a method. Referring to FIG. 2, the wireless apparatus is configured to carry out transmission of a request message, e.g. a probe request message, on a determined channel in block 202. The request message may be transmitted on a primary channel that has been detected to be used by a given wireless network, or it may be transmitted on an arbitrary channel. The information on the primary channel may be achieved through the passive scanning procedure, for example, or the channel on which the request message is transmitted may be an arbitrary channel used without any information on primary channels of any BSS. The wireless apparatus may include in the request message conditions that specify a responding device. The request message may be addressed specifically to a determined responding device, e.g. an AP, with which the requesting wireless apparatus is at this stage in an unassociated state. In some embodiments utilizing prioritization of individually addressed requests, this may realize a fast response to the request, thereby expediting the connection establishment. In another embodiment, the request message is addressed to a “wildcard” SSID which may be understood as that the request message is not addressed to any specific responding device. In this embodiment, the requesting device may receive responses from multiple responding devices and, therefore, it may improve the probability of receiving a more comprehensive list of present wireless networks.

In block 204, the wireless apparatus acquires a response message on said channel as a response to the request message, e.g. the probe response, the response message comprising information on at least two wireless networks operating on at least one of said channel and another channel. As a consequence, a responding wireless apparatus identifies in a single response message at least two wireless networks operating in the vicinity of the wireless apparatus. The responding wireless apparatus from which the response message is originated, is in the unassociated state with respect to the wireless apparatus. The wireless apparatus may additionally receive another response message from at least one other responding wireless apparatus in block 204, wherein such other responding wireless apparatus may be in an unassociated or associated state with the requesting wireless apparatus. As a result, the wireless apparatus gathers actively information on the wireless networks present in its vicinity and available for connection establishment, wherein at least one of the neighbour reports is received from a responding wireless apparatus in an unassociated state with the requesting wireless apparatus. In block 206, the wireless apparatus utilizes the gathered information in connection establishment. The wireless apparatus may select one of said at least two wireless networks with which to establish a connection and establish a connection in the selected wireless network. The connection establishment may use at least partly information contained in the received response message(s), e.g. an identifier of a wireless counterpart apparatus to which the connection is established.

Let us now consider the same operation from the point of view of the responding wireless apparatus. FIG. 3 illustrates a flow diagram of a method for an active probing procedure according to an embodiment. Referring to FIG. 3, the responding wireless apparatus acquires in block 302 the request message transferred on a channel by the requesting wireless apparatus performing the above-mentioned active scanning so as to determine the presence of wireless networks. The requesting wireless apparatus may be in an unconnected state with respect to the responding wireless apparatus, e.g. the requesting apparatus may be in an unassociated and/or unauthenticated state with respect to the responding wireless apparatus. It should be noted that the requesting wireless apparatus may be in an associated state with respect to another wireless apparatus, e.g. another AP, or the requesting wireless apparatus may be in the unassociated state with respect to any other wireless apparatus. In block 304, the responding wireless apparatus determines presence of neighbouring wireless networks, if any. In an embodiment, the determination is based on prior scanning of presence of other wireless networks and storing information on them, e.g. a network identifier, an identifier of an AP, and/or a channel identifier. In block 306, the responding wireless apparatus inserts such information on the wireless network of its own wireless network and information on at least one other neighbouring wireless network in the response message and causes transmission of the response message to the requesting wireless apparatus. The requesting wireless apparatus may still be in the unassociated state at this stage.

Each method may be carried out in a wireless apparatus, e.g. by one or more processors comprised in the wireless apparatus. The processor may be configured by program instructions stored in a memory unit of the apparatus. The methods provide information on a plurality of wireless networks in a single response message. The single response message may be transferred when the scanning device is in an unconnected state with respect to the responding device. Since the scanning device needs not to gather information on the present wireless networks from each network separately, the connection establishment is expedited. In an embodiment, the information on the plurality of networks provided in the same response message may relate to the wireless networks using the same radio access technology, e.g. IEEE 802.11, but it can be envisaged that upon development of cognitive radio technology, the responding device may be configured to include in the response message information on wireless networks utilizing different radio access technologies, e.g. IEEE 802.11 and UNITS LTE-A.

In an embodiment where the response message(s) comprise information on the channel(s) used by the present wireless networks, the scanning device may reduce the number of scanned channels on the basis of the received response message(s). For example, the scanning device may exclude at least some of the channels that are not included in any one of the response messages from the scanning, thereby expediting the scanning procedure and the preparation for the connection establishment. Reducing the number of scanned channels may include avoiding active and/or passive scanning on the excluded channel(s). Additionally, as the multiple responses are basically bundled into a single response message, the scanning time may be reduced.

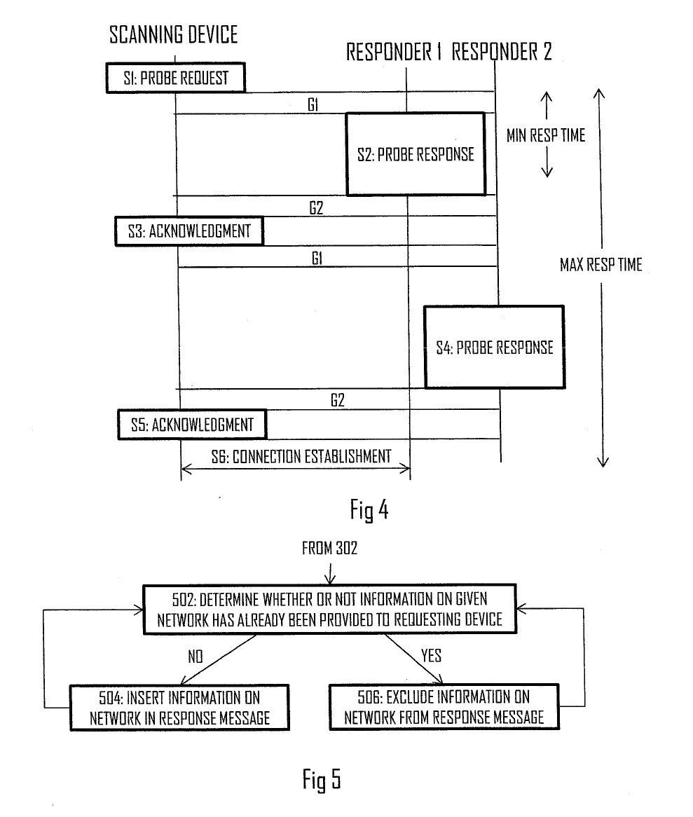

FIG. 4 illustrates a signalling diagram of an embodiment of the probing procedure the scanning device, e.g. the STA 112, carries out when preparing for the connection establishment. The scanning device may be in an unconnected state with respect to a given wireless network, or it may be completely in an unconnected state where it does not have a connection with any network. As mentioned above, the unconnected state may refer to an unassociated state and/or to an unauthenticated state. In S1, the scanning device initiates an active probing procedure and prepares a probe request message. The probe request message may be a conventional probe request message used in IEEE 802.11 networks or, when the embodiment is applied to another network, a corresponding request message in the other network. The probe request may be destined to a determined receiver, to a determined network, or to a so-called wildcard address, to provide the conditions related the devices that should respond to the probe request. A first responding device (Responder 1), a second responding device (Responder 2), and at least one other responding device may receive the probe request message transmitted by the scanning device in S1 and process the received probe request. Let us assume that the first and second responding device determine from the conditions contained in the probe request that they should respond to it, while the other responding devices determine that the request message does not oblige them to respond. After the transmission of the probe request message, there may be a guard period G1 during which channel access is prohibited. An example of the guard period G1 in an 802.11 network is a distributed inter-frame space (DIFS). After the guard period, one of the responding devices may access the channel. The channel access may be carried out through channel contention, for example. Let us assume that the first responding device gains access to the channel first, and it transmits a probe response in S2. The first probe response may be transmitted within the minimum response time shown in FIG. 4 so as to keep the scanning device on the channel on which it transmitted the probe request, as described above.

The probe response message may comprise information on any network known by the responding device to be present in the vicinity of the responding device. In order to inform the scanning device about at least one other network, the probe response message or, in general the response to the request message, may comprise the following information elements additional to the conventional probe response message:

TABLE 1

| Order | Information | Notes |
|---|---|---|
| 35 | Number of | The Number of Elements element |
| | Elements in | is present when |
| | Neighbour List | dot11_EnhancedProbing is true |
| 36 | Neighbour List | The Neighbour Report List |
| | | element is present when |
| | | dot11_EnhancedProbing is true |

Table 1 illustrates an embodiment of information elements added to a conventional IEEE 802.11 probe response message, but similar elements may be present in response messages of other networks. An information element “Number of Elements in Neighbour List” contains an unsigned integer defining the number of elements in an information element “Neighbour List”. The information element “Neighbour List” comprises a list of neighbouring networks detected by the scanning device. Example of the information element “Neighbour List” is shown below in Table 2. A separate information element of Table 2 may be included in the response message for each network reported to the scanning device.

TABLE 2

| | Ele- | | | | | Ch | | |
|---|---|---|---|---|---|---|---|---|
| | ment | | | BSSID | | num- | PHY | Optional |
| Field | ID | Length | BSSID | info | OC | ber | type | elements |
| Oc- | 1 | 1 | 6 | 4 | 1 | 1 | 1 | Variable |
| tets | | | | | | | | |

Element identifier (ID) field identifies the information element “Neighbour List”, and the Length field sets its length. The BSSID field identifies a BSS reported to the scanning device, BSSID information field specifies information on the BSS, e.g. as shown in Table 3:

TABLE 3

| AP | | | | | | | |
|---|---|---|---|---|---|---|---|
| Reach- | | Key | Capa- | Mobility | High | Very High | |
| ability | Security | Scope | bilities | Domain | Throughput | Throughput | Reserved |
| 2 bits | 1 bits | 1 bits | 6 bits | 1 bits | 1 bits | 1 bits | 19 bits |

The AP Reachability field may indicate whether the AP identified by this BSSID is reachable by the STA that requested the neighbour report. The Security bit may be used to indicate whether or not the AP identified by this BSSID supports the same security parameters as the device transmitting the response. The Key Scope bit, when set to bit value 1, may indicate whether or not the AP indicated by this BSSID has the same authenticator as the device transmitting the response. If this bit has value 0 it indicates a distinct authenticator or the information is not available. The Capabilities subfield may contain selected capability information for the AP indicated by this BSSID. The bit fields within the Capabilities subfield may have the same meaning and may be set to the equivalent bits within the Capability Information field being sent in the beacons by the AP being reported. In other words, the responding device may copy this field from a corresponding field in a beacon message received from the AP being reported. The Mobility Domain bit is may be set to 1 to indicate that the AP represented by this basic service set identifier (BSSID) is including an MDE in its beacon frames and that the contents of that MDE are identical to the MDE advertised by the device transmitting the response. The High Throughput (HT) bit may be set to 1 to indicate that the AP represented by this BSSID is an HT AP including the HT Capabilities element in its beacons, and that the contents of that HT Capabilities element are identical to the HT Capabilities element advertised by device transmitting the response. The Very High Throughput (VHT) bit may be set to 1 to indicate that the AP represented by this BSSID is a VHT AP including the VHT Capabilities element in its beacons, and that the contents of that VHT Capabilities element are identical to the VHT Capabilities element advertised by the device transmitting the response. Bits 13-31 are reserved.

An Operating Class (OC) field may specify the channel set of the AP indicated by this BSSID. Country, Operating Class, and Channel Number together may specify the channel frequency and spacing for the AP indicated by this BSSID, a physical layer (PHY) type field specifies physical layer parameters of the BSS, and optional elements field may comprise optionally included elements. In an embodiment, an optional element is a location of the AP of the reported BSS identified by the BSSID field. The location of the AP may be specified by using a Geolocation format or a civic location format both known to be used in IEEE 802.11 networks. Naturally, any means for indicating the location of the AP is possible. The scanning device may use the location information to identify an AP in a suitable location for connection establishment and, upon detecting such an AP, the scanning device may proceed directly to the connection establishment with the AP without waiting for further response messages.

The responding device may include information on a given neighbouring network in the Neighbour List element of the probe response frame, if the conditions set in probe request set the responding device to respond and if the responding device is aware of the presence of the neighbouring network. The detection of the neighbouring network may be based on the responding device monitoring for beacon messages transmitted by other devices, or it may be based on any other means for detecting the presence of neighbouring networks. In an embodiment, the responding device includes in the response message information of only those neighbouring networks that are within the coverage area of the responding device or within a specified geolocation area. Referring to FIG. 1, coverage areas 100, 102, 106 of the three networks overlap, so each of them may be configured to report the presence of the other two networks.

In an embodiment, the responding device may also evaluate the conditions set in probe request for the responding device in view of the neighbouring networks to be reported. In an embodiment, the responding device reports a neighbouring network in the response message, if the conditions set in the probe request oblige the neighbouring network to respond to the request message. On the other hand, if the responding device determines that the request message does not oblige the neighbouring network to respond to the request message, the responding device may exclude the neighbouring network from the response message. However, in an embodiment, the responding device reports also those networks that are not obliged to respond to the request message so as to provide the scanning device with a more complete report about the neighbouring networks. In such embodiments, the above-mentioned evaluation of the conditions in view of the reported neighbouring networks may be omitted.

A second guard period G2 may follow the transmission of the probe response message by the first responding device. In the embodiment of 802.11 networks, the second guard period G2 may be a short inter-frame space (SIFS). After the SIFS, the scanning device may have a priority to use the channel to transmit an acknowledgment to the probe response message in S3. In order to affect the priority, the scanning device or the responding device may have reserved the channel for the probing procedure by setting, for example, a network allocation vector (NAV) on the channel. The first guard period G1 may again follow the transmission of the acknowledgment and, thereafter, the channel is free for transmission of further probe responses. In S4, the second responding device gains access to the channel to transmit a probe response of its own. This probe response may comprise information on at least one network not yet reported to the scanning device. Further embodiments for filtering the number of reported networks are described below. The scanning device acknowledges the second probe response in S5 after the second guard period G2. Thereafter, further probe responses may be exchanged during the response time set by the maximum response time parameter, if applicable, and the scanning device then selects a network to connect to and establishes the connection in S6. The scanning device may start the connection establishment after the maximum response time has elapsed or, if the scanning device finds a suitable network, it may start the connection establishment procedure before the maximum response time has elapsed. In another embodiment, the scanning device reduces the number of scanned channels on the basis of the active scanning procedure by directing the scanning to only those channels reported in the probe responses. Then, the scanning device tunes to scan those channels by listening beacon messages and/or sending probe requests. As a consequence, the detection of the candidates for the connection establishment are expedited which speeds up the connection establishment.

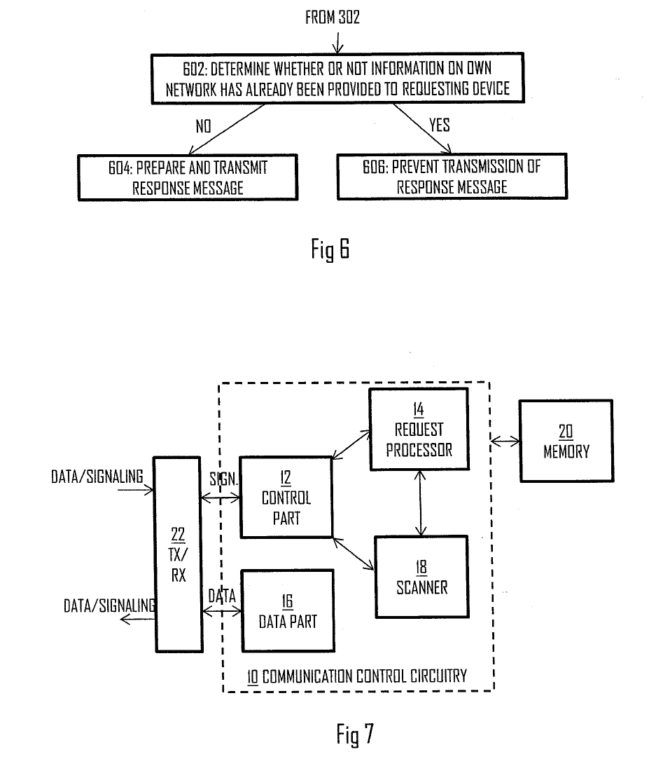

FIGS. 5 and 6 illustrate embodiments for reducing the signalling overhead during the active probing procedure, and they may be applied to the embodiments of FIG. 3 or 4. Processes described in FIGS. 5 and 6 may be realized in a wireless apparatus configured to respond to a request message, e.g. the probe request. FIG. 5 relates to an embodiment where the responding device excludes from the response message information on at least one neighbouring network that has already been reported to the scanning device, while FIG. 6 relates to an embodiment where the responding device omits responding to the request message if the information on the responding device's network has already been provided to the scanning device. These embodiments reduce the size of the response messages and, thus, the signalling overhead. They also reduce the amount of processing required in the scanning device, thus expediting the connection establishment. Both embodiments may be based on monitoring the active probing procedures of the wireless apparatuses within the coverage area of the wireless network. The responding device may be configured to monitor for the response messages transmitted by the other responding devices so as to construct a database comprising cross references between wireless apparatuses and wireless networks reported to each wireless apparatus.

Referring to FIG. 5, let us consider the process that may be comprised in the process of FIG. 3. Upon receiving the request message in block 302 in the wireless apparatus and upon determining that the wireless apparatus should respond to the request message, the wireless apparatus determines the neighbouring networks that are present in the vicinity of the wireless apparatus (block 304). Block 304 may comprise block 502 as a sub-routine, wherein block 502 comprises determining for each neighbouring network whether or not the information on the neighbouring network has already been provided to the apparatus from which the request message was received. If information on a network is determined not to have been reported to the requesting apparatus in any response message, the process proceeds to block 504 in which the information on the network is inserted in the response message. On the other hand, if the information on a network is determined to have already been reported to the requesting apparatus in any previous response message, the process proceeds to block 506 in which the information on the network is not included in the response message. From blocks 504 and 506 the process may return to block 502 if there are any further networks to be considered when preparing the response message. After all the present networks have been considered, the preparation of the response message may be completed and the transmission of the response message to the requesting apparatus may be carried out.

In an embodiment, block 502 comprises determining whether or not:
the wireless apparatus has received from the requesting apparatus a request message specifying a condition obliging the wireless apparatus to respond to the request message.
the wireless apparatus has detected a response message transmitted by at least one other wireless apparatus in response to the request message and that response message transmitted by said at least one other wireless apparatus comprises information on the wireless network being considered; and
the wireless apparatus has detected that the requesting apparatus has acknowledged reception of the response message transmitted by said at least one other wireless apparatus comprising said information on the wireless network being considered.

If the above-mentioned conditions are all fulfilled, the process may proceed to block 506 and, otherwise, the process may proceed to block 504. Referring to FIG. 1, if the AP 110 is the wireless apparatus and the STA 112 is the requesting apparatus, and if the AP 110 has detected that the presence of the AP 104 has already been transmitted to the STA 112, the AP 110 may include in the response message information on only its own network and the network of the STA 108. Depending on the processing capability of the wireless apparatus and/or any other conditions, block 502 may take into account only the earlier probing procedures or also the current probing procedure. For example, referring to FIG. 4 the first responding device responding first to the probe request may use only the information on the neighbouring networks reported in connection with earlier probing requests. However, the second responding device may take into account the neighbouring networks reported in connection with earlier probing requests and, optionally, the neighbouring networks reported in connection with current probing request of S1. In practice, the second scanning device may monitor for and detect the probe response transmitted in S2 and associated acknowledgment in S3 to derive the networks reported in S2. Then, the second responding device may exclude from the probe response transmitted in S4 information on any network reported in the probe response of S2. This fast adaptation by the second responding device further reduces the signalling overhead by reducing the size of the response message.

In an embodiment, the responding device is configured to report only the neighbouring networks operating on fully or partly on the same channel(s) as the responding device. In another embodiment, the responding device is configured to report, in addition to its own network, only the networks on non-overlapping channels. In yet another embodiment, the responding device is configured to report all the networks it has discovered regardless of their operating channels. The procedure of FIG. 5 may be applied only to the networks the responding device is configured to report.

Referring to FIG. 6, let us consider the process that may be comprised in the process of FIG. 3. Upon receiving the request message in block 302 in the wireless apparatus and upon determining that the wireless apparatus should respond to the request message, the wireless apparatus determines in block 602 whether or not the information on the network of the wireless apparatus has already been provided to the apparatus from which the request message was received. If the information on the network of the wireless apparatus is determined not to have been reported to the requesting apparatus in any response message, the process proceeds to block 604 in which the wireless apparatus is configured to start the preparation of the response message, e.g. by proceeding to block 304 or 502. On the other hand, if the information on the network of the wireless apparatus is determined to have already been reported to the requesting apparatus in any previous response message, the process proceeds to block 606 in which the transmission of the response message is prevented even though the wireless apparatus is conditioned by the request message to respond.

In an embodiment, block 602 comprises determining whether or not:
the wireless apparatus has received from the requesting apparatus a request message specifying a condition obliging the wireless apparatus to respond to the request message.
the wireless apparatus has detected a response message transmitted by at least one other wireless apparatus in response to the request message and that response message transmitted by said at least one other wireless apparatus comprises information on the wireless network of the wireless apparatus; and
the wireless apparatus has detected that the requesting apparatus has acknowledged reception of the response message transmitted by said at least one other wireless apparatus comprising said information on the wireless network of the wireless apparatus.

If the above-mentioned conditions are all fulfilled, the process may proceed to block 606 and, otherwise, the process may proceed to block 604. Depending on the processing capability of the wireless apparatus and/or any other conditions, block 602 may take into account only the earlier probing procedures or also the current probing procedure. For example, referring to FIG. 4 the first responding device responding first to the probe request may use only the information acquired from the earlier probing requests. However, the second responding device may take into account the information acquired from the earlier probing requests/responses and, optionally, the information acquired in connection with current probing request of S1. In practice, the second scanning device may monitor for and detect the probe response transmitted in S2 and associated acknowledgment in S3 to derive whether or not the network of the second responding device has been reported in the response message of S2. Then, the second responding device may prevent the transmission of the probe response of S4, if its network has been reported in the probe response of S2. This fast adaptation by the second responding device further reduces the signalling overhead by reducing the number of the transmitted response messages.

A modification of the embodiment of FIG. 6 and, particularly, block 606 is that the wireless apparatus is configured to carry out the response even the network of the wireless apparatus has already been reported to the requesting apparatus, if the wireless apparatus detects a neighbouring network that has not yet been reported to the requesting apparatus. As a consequence, this embodiment may be seen as a combination of embodiments of FIGS. 5 and 6, wherein block 606 is replaced by block 502.

In some cases the responding device may selectively retransmits response message received from another responding device. The responding device may consider the geolocation of the other responding device and retransmit the received response message, if it considers that it may distribute the response message to larger area with the retransmission. In another embodiment, the responding device may extract information on the reported neighbour networks from the received response message and add information on any neighbouring network it has not yet reported itself. Accordingly, the responding device may be understood as not simply retransmitting the received response message but, instead, completing its own response message with non-overlapping information included in the received response message.

Above, the probe request and probe response messages have been described as embodiments for realizing the respective request message and the response message in an 802.11 based network. Another embodiment for the request message in the 802.11 network is a generic advertising service (GAS) request message, and a corresponding response message may be a GAS response message. As known in connection with the 802.11 networks, the GAS provides for Layer 2 transport of advertisement protocol frames between a mobile device (STA) and a server in the network prior to authentication. An AP may be responsible for relaying a STA's query to a server in the carrier's network and for delivering the server's response back to the STA. As a consequence, the request-response process may be carried out between a STA and the AP or between the STA and the server via an AP. The server may function as the above-described responding device, or the responding device may be the AP configured to relay the GAS requests and responses between a STA and the server and to monitor for GAS responses of other APs.

FIG. 7 illustrates an embodiment of an apparatus comprising means for carrying out the above-mentioned functionalities of the wireless apparatus configured to process received request messages and respond to then, if applicable. The apparatus may be a communication apparatus of an IEEE 802.11 network or another wireless network, e.g. an AP. The apparatus may be a computer (PC), a laptop, a tablet computer, a cellular phone, a palm computer, a fixed base station operating as the AP, or any other apparatus provided with radio communication capability. In another embodiment, the apparatus is comprised in such a communication apparatus, e.g. the apparatus may comprise a physical circuitry, e.g. a chip, a processor, a micro controller, or a combination of such circuitries in the communication apparatus.

The apparatus may comprise a communication controller circuitry 10 configured to control the communications in the communication apparatus. The communication controller circuitry 10 may comprise a control part 12 handling control signalling communication with respect to transmission, reception, and extraction of control frames including the request messages, the response messages, and the acknowledgment messages, as described above. The communication controller circuitry 10 may further comprise a data part 16 that handles transmission and reception of payload data during transmission opportunities of the communication apparatuses (transmission) or transmission opportunities of other communication apparatuses (reception). The communication controller circuitry 10 may further comprise a request processor 14 configured to carry out at least some of the request processing procedures described above. The request processor 14 may acquire a request message through the control part 12 and to process the request message so as to determine whether or not to respond to the request. Upon determining that the request should be responded, the request processor 14 is configured to start the preparation of the response message to report one or more present networks to the requesting apparatus, as described above. The list of present neighbouring networks may be stored in a memory unit 20. The control part 12 may further be configured to receive control or management messages transmitted by other apparatuses, and the communication control circuitry 10 may further comprise a scanner circuitry 18 configured to process such control messages. The scanner circuitry 18 may be configured to monitor for any beacon signals to derive the presence of neighbouring networks and to store the information on the present neighbouring networks in the memory 20. The scanner circuitry 18 may also be configured to monitor for the response messages transmitted by the other apparatuses and associated acknowledgment messages. Then, the scanner circuitry 18 may extract the received response messages so as to determine an identifier of a requesting apparatus from a destination address of the response messages and, additionally, information the neighbouring networks contained in the “Neighbour List” information element in the response message. If the scanner circuitry 18 also detects the acknowledgment for the response message, it stores in the memory 20 identifiers of the networks contained in the Neighbour List in association with the identifier of the requesting device so as to provide the cross-reference between the requesting device and present networks that have been reported to the requesting device. As a consequence, the request processor is able to determine from this cross-reference the networks to be included in the response message, if any.

The circuitries 12 to 18 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 12 to 18 or all of them.

The memory 20 may further store computer programs (software) configuring the apparatus to perform the above-described functionalities of the communication apparatus. The memory 20 may also store communication parameters and other information needed for the wireless communications, e.g. the database storing information on the present neighbouring networks and the list of networks already reported to each STA. The apparatus may further comprise radio interface components 22 providing the apparatus with radio communication capabilities within the BSS and/or with other BSSs. The radio interface components 22 may comprise standard well-known components such as amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention in the communication apparatus comprises at least one processor and at least one memory including a computer program code, wherein the at least one memory and the computer program code are configured, with the at least one processor, to cause the apparatus to carry out the functionality of the responding device in any one of the processes of FIGS. 3 to 6. Accordingly, the at least one processor, the memory, and the computer program code form processing means for carrying out embodiments of the present invention in the wireless communication apparatus processing request messages.

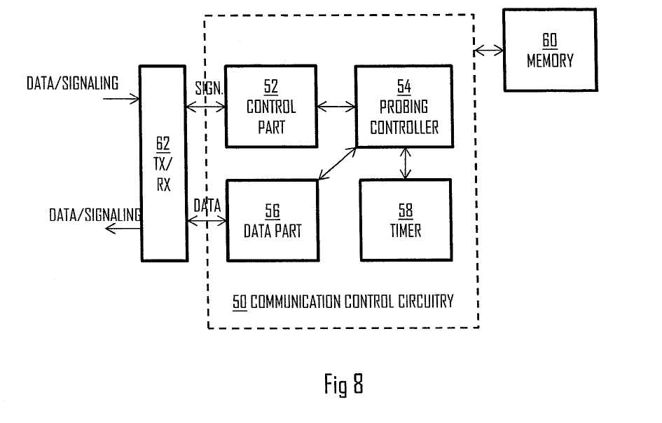

FIG. 8 illustrates an embodiment of an apparatus comprising means for carrying out the above-mentioned functionalities of the wireless apparatus configured to cause transmission of request messages and to process received response messages. The apparatus may be a communication apparatus of an IEEE 802.11 network or another wireless network, e.g. a STA. The apparatus may be a computer (PC), a laptop, a tablet computer, a cellular phone, a palm computer, or any other apparatus provided with radio communication capability. In another embodiment, the apparatus is comprised in such a communication apparatus, e.g. the apparatus may comprise a physical circuitry, e.g. a chip, a processor, a micro controller, or a combination of such circuitries in the communication apparatus.

The apparatus may comprise a communication controller circuitry 50 configured to control the communications in the communication apparatus. The communication controller circuitry 50 may comprise a control part 52 handling control signalling communication with respect to transmission, reception, and extraction of control frames including the request messages, the response messages, and the acknowledgment messages, as described above. The communication controller circuitry 50 may further comprise a data part 56 that handles transmission and reception of payload data during transmission opportunities of the communication apparatuses (transmission) or transmission opportunities of other communication apparatuses (reception). The communication controller circuitry 50 may further comprise a probing controller 54 configured to carry out the probing procedures in the above-mentioned requesting device. The probing controller 54 may process and transmit the request message through the control part 52 as a part of the active probing procedure and to process any response message received as a response to the request message. The probing controller 54 may be configured to derive the information on the plurality of present networks from a single response message during the unconnected state, as described above. Upon deriving the information on the present networks, the probing controller 54 may configure the control part 52 to limit the number of channels scanned in the connection establishment procedure, thus expediting the connection establishment. The communication controller circuitry 50 may further comprise a timer 58 measuring the above-mentioned minimum and maximum response time.

The circuitries 52 to 58 of the communication controller circuitry 50 may be carried out by the one or more physical circuitries or processors. In practice, the different circuitries may be realized by different computer program modules. Depending on the specifications and the design of the apparatus, the apparatus may comprise some of the circuitries 52 to 58 or all of them.

The apparatus may further comprise a memory 60 to store computer programs (software) configuring the apparatus to perform the above-described functionalities of the communication apparatus. The memory 20 may also store communication parameters and other information needed for the wireless communications, e.g. the database storing information on the present neighbouring networks and their operational parameters, e.g. operating channels. The apparatus may further comprise radio interface components 62 providing the apparatus with radio communication capabilities within the BSS and/or with other BSSs. The radio interface components 62 may comprise standard well-known components such as amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention in the communication apparatus comprises at least one processor and at least one memory including a computer program code, wherein the at least one memory and the computer program code are configured, with the at least one processor, to cause the apparatus to carry out the functionality of the requesting device in any one of the processes of FIGS. 2 and 4. Accordingly, the at least one processor, the memory, and the computer program code form processing means for carrying out embodiments of the present invention in the apparatus functioning in the requesting device.

As used in this application, the term ‘circuitry’ refers to all of the following: (a) hardware-only circuit implementations, such as implementations in only analog and/or digital circuitry, and (b) to combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) to circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular element, a baseband integrated circuit or applications processor integrated circuit for a mobile phone or a similar integrated circuit in server, a cellular network device, or other network device.

The processes or methods described in FIGS. 4 to 8 may also be carried out in the form of a computer process defined by a computer program. The computer program may be in source code form, object code form, or in some intermediate form, and it may be stored in some sort of transitory or non-transitory carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to cellular or mobile telecommunication systems defined above but also to other suitable telecommunication systems. The cellular telecommunication system may have a fixed infrastructure providing wireless services to subscriber terminals and having the same cellular structure as another cellular telecommunication system from. The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment.

It will be obvious to a person skilled in the art that, as technology advances, the inventive concept can be implemented in various ways. The invention and its embodiments are not limited to the examples described above but may vary within the scope of the claims.

1-29. (canceled)

30. A method, comprising:
causing, by a wireless apparatus, transmission of a request message on a channel;
acquiring, by the wireless apparatus, a response message on said channel as a response to the request message, the response message being originated from a second wireless apparatus which is in an unassociated state with said wireless apparatus, and the response message comprising information on at least two wireless networks operating on at least one of said channel and another channel; and
utilizing, by the wireless apparatus, the received response message for a connection establishment.

31. The method of claim 30, further comprising: upon acquiring the response message, reducing a set of channels to be scanned for the connection establishment on the basis of the information on the at least two wireless networks.

32. The method of claim 30, wherein the wireless apparatus is a non-access point station, the method further comprising: addressing the request message to at least one access point.

33. The method of claim 30, the utilization of the received response message comprising:
selecting one of said at least two wireless networks with which to establish a connection; and
establishing a connection in the selected wireless network.

34. The method of claim 30, wherein the request message is at least one of a probe request message and a generic advertisement service request message and the response message is at least one of a probe response message and a generic advertisement service response message.

35. A method, comprising:
acquiring, by a first apparatus for a wireless network, a request message transferred on a channel from a second wireless apparatus which is in an unassociated state with respect to the first wireless apparatus;
determining, by the first apparatus, presence of neighbouring wireless networks; and
inserting, by the first apparatus, information on the wireless network and neighbouring wireless networks in a response message; and
causing, by the first apparatus transmission of the response message to the second wireless apparatus.

36. The method of claim 35, further comprising:
monitoring, by the first apparatus, for response messages transmitted by at least one other apparatus to the second wireless apparatus;
determining, by the first apparatus, from the response messages received from at least one other wireless apparatus whether or not information on a given wireless network to be included in the response message has already been delivered to the second wireless apparatus;
upon determining that the information on the given wireless network has already been delivered to the second wireless apparatus, excluding, by the first apparatus, said information from the response message to be transmitted to the second wireless apparatus.

37. The method of claim 35, wherein the request message comprises at least one information element specifying a condition on the basis of which the first wireless apparatus determines whether or not to respond to the request message, the method further comprising:
preventing transmission of the response message if the following conditions are fulfilled: the first wireless apparatus has received from the second wireless apparatus a request message specifying a condition obliging the first wireless apparatus to respond to the request message; the first wireless apparatus has detected a response message transmitted by at least one other wireless apparatus in response to the request message and that the response message transmitted by said at least one other wireless apparatus comprises information on the wireless network of the first wireless apparatus, and the first wireless apparatus has detected that the second wireless apparatus has acknowledged reception of the response message transmitted by said at least one other wireless apparatus.

38. An apparatus, comprising:
at least one processor; and
at least one memory including program instructions, wherein the at least one memory and the computer program code are configured, with the at least one processor, to cause the apparatus in preparation for connection establishment to:
cause transmission of a request message on a channel;
acquire a response message through said channel as a response to the request message, the response message being originated from a second wireless apparatus which is in an unassociated state with said apparatus, and the response message comprising information on at least two wireless networks operating on at least one of said channel and another channel; and
utilizing the received response message in the connection establishment.

39. The apparatus of claim 38, wherein the at least one memory and the computer program code are configured, with the at least one processor, to cause the apparatus upon acquiring the response message to reduce a set of channels to be scanned for the connection establishment on the basis of the information on the at least two wireless networks.

40. The apparatus of claim 38, wherein the at least one memory and the computer program code are configured, with the at least one processor, to cause the apparatus to address the request message to at least one other wireless apparatus by inserting an address of the at least one other wireless apparatus in the request message.

41. The apparatus of claim 38, wherein the at least one memory and the computer program code are configured, with the at least one processor, to cause the apparatus to utilize the received response message by selecting one of said at least two wireless networks with which to establish a connection; and causing establishment of a connection in the selected wireless network.

42. The apparatus of claim 38, wherein the request message is at least one of a probe request message and a generic advertisement service request message and the response message is at least one of a probe response message and a generic advertisement service response message.

43. An apparatus comprising:
at least one processor; and
at least one memory including program instructions, wherein the at least one memory and the computer program code are configured, with the at least one processor, to cause the apparatus in preparation for connection establishment to:
acquire a request message transferred through a channel from a second wireless apparatus which is in an unassociated state with respect to the apparatus;
determine presence of neighbouring wireless networks; and
insert information on wireless network of the apparatus and neighbouring wireless networks in a response message; and
cause transmission of the response message to the second wireless apparatus.

44. The apparatus of claim 43, wherein the at least one memory and the computer program code are configured, with the at least one processor, to cause the apparatus to:
monitor for response messages transmitted by at least one other apparatus to the second wireless apparatus;
determine from the response messages received from at least one other wireless apparatus whether or not information on a given wireless network to be included in the response message has already been delivered to the second wireless apparatus;
upon determining that the information on the given wireless network has already been delivered to the second wireless apparatus, exclude said information from the response message to be transmitted to the second wireless apparatus.

45. The apparatus of claim 43, wherein the at least one memory and the computer program code are configured, with the at least one processor, to cause the apparatus to:
determine whether or not to respond to the request message on the basis of at least one information element comprised in the request message and specifying a condition for said responding; and
prevent transmission of the response message if the following conditions are fulfilled: the apparatus has acquired from the second wireless apparatus a request message specifying a condition obliging the apparatus to respond to the request message; the apparatus has detected a response message transmitted by at least one other wireless apparatus in response to the request message and that the response message transmitted by said at least one other wireless apparatus comprises information on the wireless network of the apparatus, and the apparatus has detected that the second wireless apparatus has acknowledged reception of the response message transmitted by said at least one other wireless apparatus.

46. The apparatus of claim 43, wherein the at least one memory and the computer program code are configured, with the at least one processor, to cause the apparatus to inserting into the response message information on at least one neighbouring wireless network operating on the same channel through which the request message was transferred.

47. The apparatus of claim 43, wherein the at least one memory and the computer program code are configured, with the at least one processor, to cause the apparatus to insert into the response message information on at least one neighbouring wireless network operating on a channel different from the channel through which the request message was transferred.

48. The apparatus of claim 43, wherein the information on a wireless network comprised in the response message comprises an identifier of the wireless network and at least one operating channel identifier of the wireless network.

49. The apparatus of claim 43, wherein the request message is at least one of a probe request message and a generic advertisement service request message and the response message is at least one of a probe response message and a generic advertisement service response message.
